(19) United States
(12) Patent Application Publication
(10) Pub. No.: US 2024/0103572 A1
(43) Pub. Date: Mar. 28, 2024

(54) FLEXIBLE WEARABLE TENSION MEMBER WITH CABLE MANAGEMENT

(71) Applicant: Apple Inc., Cupertino, CA (US)

(72) Inventors: Liam R. Martinez, San Francisco, CA (US); Javier Mendez, San Jose, CA (US); Samuel G. Smith, San Francisco, CA (US)

(21) Appl. No.: 18/452,353

(22) Filed: Aug. 18, 2023

Related U.S. Application Data
(60) Provisional application No. 63/376,744, filed on Sep. 22, 2022.

(51) Int. Cl. G06F 1/16

(52) U.S. Cl. CPC G06F 1/163

(57) ABSTRACT

In at least one example of the present disclosure, a head mountable display includes a display module, a band including a first end and a second end, a first electrical connector disposed at the first end, the first electrical connector removably attachable to the display module, a second electrical connector disposed at the second end, the second electrical connector removably attachable to the display module, a battery electrically attachable to the band, a cable positioned within the band electrically connecting the battery to the first electrical connector, and an elastomeric cover disposed around the cable, the elastomeric cover imparting a tension force to the band.

### CROSS-REFERENCE TO RELATED APPLICATION(S)

This claims priority to U.S. Provisional Patent Application No. 63/376,744, filed 22 Sep. 2022, and entitled “Flexible Wearable Tension Member with Cable Management,” the entire disclosure of which is hereby incorporated by reference.

### FIELD

The present disclosure relates generally to wearable electronic devices. More particularly, the present disclosure relates to electronic modules and component of head-mountable displays.

### BACKGROUND

Recent advances in portable computing have enabled devices that provide augmented and virtual (AR/VR) experiences to users. Various components of these devices, such as display screens, speakers, antennas, battery packs, and the like, operate together to provide an immersive AR/VR experience to the user. Head-mountable display (HMD) devices are one example of an AR/VR device that provide these immersive experiences. HMD devices can include display screens secured over the eyes of the user and can also include one or more of the components listed above distributed throughout the system. However, the inclusion of the various components often results in a network of cables that need to be efficiently and thoughtfully routed throughout the system.

### SUMMARY

In at least one example of the present disclosure, a head mountable display includes a display, a band including a first end and a second end, a first electrical connector disposed at the first end that is removably attachable to the display, a second electrical connector disposed at the second end that is removably attachable to the display, a battery electrically attachable to the band, a cable positioned within the band electrically connecting the battery to the first electrical connector, and an elastomeric cover disposed around the cable. The elastomeric cover can impart a tension force to the band.

In one example, the tension force in the band corresponds to an elastomeric spring force of the elastomeric cover. In one example, the elastomeric cover of the cable is fixedly connected to the first electrical connector and to the second electrical connector. In one example, the head mountable display further includes a speaker disposed within the band, the speaker electrically connected to the battery and to the display module via the cable. In one example, the head mountable display further includes a lumen defined by the elastomeric cover, the lumen extending from the speaker to an open volume. In one example, the open volume is defined by the battery. In one example, the cable includes a first cable and a second cable with the elastomeric cover disposed around the first cable and the second cable.

In at least one example of the present disclosure, a band for coupling a first electronic module to a second electronic module includes a body having a first end and a second end, a cable positioned within the body and configured to electrically connect the first electronic module to the second electronic module. The cable includes a first conductor, a second conductor, and an elastomeric cover disposed around the first conduct and the second conductor. The elastomeric cover provides an elastomeric spring force to provide tension to the band. The cable is disposed in a predetermined geometric pattern such that the cable is maintained in the predetermined pattern in an unconstrained state

In one example, the predetermined geometric pattern of the cable is repeating. In one example, the predetermined geometric pattern of the cable is a sine wave. In one example, the predetermined geometric pattern of the cable is an S bend. In one example, a first insulator is disposed around the first conductor of the cable and a second insulator is disposed around the second conductor of the cable. In one example, a first fastener at the first end of the band connects the first end of the band to a first electrical connector and a second fastener at the second end of the band connects the second end of the band to a second electrical connector.

In at least one example of the present disclosure, a wearable electronic device includes a display, a battery, a flexible band to connect the display to the battery, a first and second conductor, and an elastomeric cover disposed within the band and surrounding the first conductor and the second conductor. The elastomeric cover imparts a tension force to the band.

In one example, the elastomeric cover maintains the first and second conductor in a predetermined location in the band. In one example, the first and second conductor have a helical coil shape. In one example, the elastomeric cover insulates the first and second conductor. In one example, the wearable electronic device further includes a first insulator disposed between the first conductor and the elastomeric cover, and a second insulator disposed between the second conductor and the elastomeric cover. In one example, the wearable electronic device further includes an electronic module, wherein the electronic module is electrically connected to the display and the battery via the first and second conductor. In one example, the electronic module includes a speaker and the elastomeric cover defines a lumen, the lumen extending from the speaker to a remote volume. In one example, the remote volume is defined by a battery housing.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a perspective view of a wearable electronic device, in accordance with some embodiments.

FIG. 2 illustrates a side view of a user with a band of a wearable electronic device stretched to be worn by a user, in accordance with some embodiments.

FIG. 3 illustrates a side view of a wearable electronic device being worn by a user, in accordance with some embodiments.

FIG. 4 illustrates a side view of a wearable electronic device with a display, a battery, and a speaker, in accordance with some embodiments.

FIG. 5 illustrates a plurality of cables with an elastomeric cover, in accordance with some embodiments.

FIG. 6 illustrates a plurality of cables with an elastomeric cover, in accordance with some embodiments.

FIG. 7A illustrates a cable with a helical coil shape disposed in an elastomeric cover, in accordance with some embodiments.

FIG. 7B illustrates an elastomeric tube with a hollow lumen, in accordance with some embodiments.

FIG. 8 illustrates a band for a wearable electronic device with a cable disposed in the band with an elastomeric cover in a sine wave geometric pattern, in accordance with some embodiments.

FIG. 9 illustrates a band for a wearable electronic device with a cable disposed in the band with an elastomeric cover in an S bend geometric pattern, in accordance with some embodiments.

FIG. 10 illustrates a band for a wearable electronic device with a cable disposed in the band with an elastomeric cover in a helical coil geometric pattern, in accordance with some embodiments.

FIG. 11 illustrates a band for a wearable electronic device with a cable disposed in the band with an elastomeric cover in a square coil geometric pattern, in accordance with some embodiments.

FIG. 12 illustrates a band for a wearable electronic device with a cable disposed in the band with an elastomeric cover in a snake bend geometric pattern, in accordance with some embodiments.

### DETAILED DESCRIPTION

The following description references representative embodiments illustrated in the accompanying drawings. However, the descriptions are not intended to limit the embodiments to one preferred embodiment, but are intended to cover alternatives, modifications, and equivalents as can be included within the spirit and scope of the described embodiments as defined by the appended claims.

As virtual reality (VR) and mixed reality (MR) become more ubiquitous, the demand for user friendly head-mounted displays with quality components increases. Traditionally, these VR/MR systems have been devices that include a wearable display component, often referred to as a head-mounted display (HMD). Typically a band can be used to secure the HMD to a user's head. The band can be flexible and can include a tension force that secures the HMD to the user's head without using an excess tension force that is uncomfortable for the user.

The HMD devices disclosed herein describe a band for securing the HMD to a user's head. Cables can be disposed in the band to connect various electronic modules or “electronics” of the HDM together, such as the display, power sources, antenna, sensors, power module, batteries, camera, processors, circuits or circuit boards, and the like. The cables can include an elastomeric cover that imparts a tension force to the band. The tension force can correspond to an elastomeric spring force of the elastomeric cover of the cable.

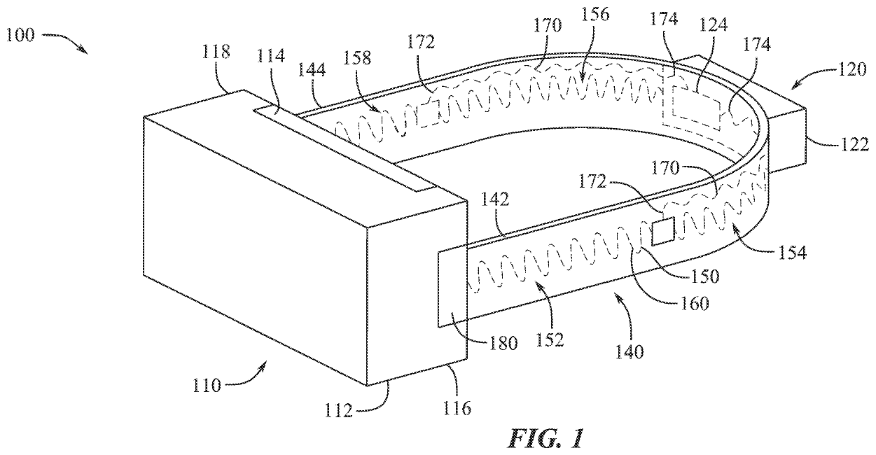

These and other embodiments are discussed below with reference to FIGS. 1-12. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a wearable electronic device 100 that includes a first electronic module 110, a second electronic module 120, a third electronic module 130, and a band 140 for securing the first electronic module to a user. As shown, a cable 150 is disposed and positioned within the band and is configured to electrically couple the first electronic module 110, the second electronic module 120, and the third electronic module 130. The cable 150 can include wires or another suitable conductor. In some examples, the cable 150 can include a plurality of wires. In some examples, each wire of the cable can be dedicated to a specific transfer, such as data or power, with each wire being insulated from the other wires. Although referred to as a wearable electronic device 100, it should be understood that the wearable electronic device 100 can include multiple modular components or devices, and can be interchangeably referred to as a wearable electronic device, wearable electronic device system, and/or wearable electronic system.

The first electronic module 110 can be a head mounted display (HMD) that includes a housing 112 and a display 114 attached to the housing 112 for displaying images to a user donning the wearable electronic device 100. Although the first electrical module 110 can be referred to as an HMD, it should be understood that the terms HMD, HMD device, and/or HMD system can be used to refer to the wearable electronic device 100 as a whole.

The second electronic module 120 can include a battery that is electrically coupled via the cable 150 to the first electronic module 110 to provide power to the first electronic module 110. The second electronic module 120 includes a housing 122 for housing a power source of the second electronic module 120. The second electronic module 120 can be removably attachable to the band 140 or can be integral with the band 140. The second electronic module 120 can be secured to the band 140 in a number of different ways. In some examples, the band 140 can include a pocket in which the second electronic module 120 can be inserted into and removed from.

The second electronic module 120 is coupled to the band 140 and is disposed in location opposite from the first electronic module 110. For example, the first electronic module 110 can be disposed in the front of the wearable electronic device 100, and the second electronic module 120 can be disposed in the rear of the wearable electronic device 100. In some examples, the first electronic module 110 and the second electronic module 120 can have a similar mass or weight. Accordingly, the second electronic module 120 can act as a counterweight to the first electronic module 110. This can add to the comfort level experienced by the user by not making the forward side or the rear side of the wearable electronic device 100 heavier than the other, which would add strain to the user to balance the overall weight of the wearable electronic device 100.

The third electronic module 130 can be a variety of different components that are removably attached to or integral with, the band 140. For example, the third electronic module 130 can be a speaker, antenna, sensors, power module, batteries, camera, processors, circuits or circuit boards, and the like. In the illustrated embodiment, the third electronic module 130 is disposed within the band and is electrically coupled to the first electronic module 110 and the second electronic module 120. The illustrated embodiment illustrates two of the third electronic modules 130, however, the present disclosure is not so limited. The wearable electronic device 100 can include two, three, more, or less than two of the third electronic modules 130. In some examples, multiple third electronic modules 130 can be the same type of components (e.g., speakers). In some examples, the third electronic modules 130 can be a variety of different types of components, (e.g., speaker, antenna, sensors, power module, batteries, camera, processors, circuits or circuit boards, and the like).

In the illustrated embodiment, the third electronic modules 130 are speakers, with one of the third electronic modules 130 disposed on a left side of the band 140 to engage with the left ear of the user, and another of the third electronic modules 130 disposed on the right side of the band 140 to engage with the right ear of the user.

The band 140 can be used to secure the wearable electronic device 100 to the user during use. The band 140 can include a first end 142 that is coupled to a first end 116 of the housing 112 of the first electronic module 110, and a second end 144 that is coupled to a second end 118 of the housing 112 of the first electronic module 110. The first end 142 and the second end 144 of the band 140 can be removably attachable to the housing 112 of the first electronic module 110. The band 140 can be a number of different materials, such as fabrics (e.g., woven, knitted, non-woven), foams, and the like.

In some embodiments, the band 140 can include electrical connectors 180 disposed on the first end 142 and the second end 144 of the band. Accordingly, there is a first electrical connector and a second electrical connector that are configured to be removably attachable to the first electronic module 110. The electrical connectors 180 provide a physical and an electrical connection between the band 140 and the first electronic module 110. In some embodiments, the band 140 can include a band that extends over the head of the user, in addition to around the circumference of the user's head.

The cable 150 can be disposed and positioned within the band 140. The cable 150 is a conductor that is configured to electrically couple the first electronic module 110, the second electronic module 120, and/or the third electronic module 130, and to transmit power and/or data between the first electronic module 110, the second electronic module 120, and the third electronic module 130. For ease of illustration, only a single cable 150 is illustrated that electrically couples all of the modules 110, 120, 130 together. However, the band 140 can further include additional cables dedicated to power transfer, a power cable to couple the first electronic module 110 (e.g. HMD) to the second electronic module 120 (e.g., battery), and a power cable to couple third electronic module 130 (e.g., speaker) to the second electronic module 120 (e.g., battery). In some examples, the cable 150 can include a plurality of wires with each wire dedicated to a specific transfer, power, data, etc.

The cable 150 can have an elastomeric cover 160. The cable 150 with the elastomeric cover 160 can be positioned in a predetermined geometric pattern within the band 140. The elastomeric cover 160 helps maintain the cable 150 in the predetermined geometric pattern to prevent the cable 150 from drastically moving within the band 140 during use. In addition, the elastomeric cover 160 imparts a tension force to the band 140. The tension force corresponds to an elastomeric spring force of the elastomeric cover 160. Accordingly, the band 140 can be stretched, and the elastomeric constant spring force of the elastomeric cover 160 resiliently returns the cable 150 to its predetermined geometric shape and simultaneously resiliently returns the band 140 to its predetermined size or unconstrained state of FIG. 1.

In some embodiments, the cable 150 can further include an insulator cover that insulates the cable 150. The insulator cover can be disposed between the cable 150 and the elastomeric cover 160. In some embodiments, the elastomeric cover 160 is also the insulator.

The wearable electronic device 100 illustrates a single cable 150 with a plurality of distinct segments. The cable 150 can be used to transfer data between the first electronic module 110, the second electronic module 120, and the third electronic modules 130. A first segment 152 electrically couples the first electronic module 110 to the third electronic module 130 disposed on a left side of the wearable electronic device 100. A second segment 154 electrically couples the third electronic module 130 disposed on the left side of the wearable electronic device 100 to the second electronic module 120. A third segment 156 electrically couples the second electronic module 120 to the third electronic module 130 disposed on a right side of the wearable electronic device 100. A fourth segment 158 electrically couples the third electronic module 130 to the first electronic module 110.

In some examples, the wearable electronic device 100 can include a plurality of cables 150 each with their own elastomeric cover 160 disposed in a predetermined geometric pattern. The number of cables with elastomeric covers, and their respective properties, can be determinative of the tension that the plurality of cables and their respective elastomeric cover 160 provide to the band 140.

In some examples, the elastomeric cover 160 can include a plurality of cables disposed within the elastomeric cover 160. For example, the elastomeric cover 160 can include a first cable for power transfer and a second cable for data transfer.

In some examples, the wearable electronic device 100 can further include an elastomeric tube 170. In the illustrated embodiment, the wearable electronic device 100 includes two elastomer tubes 170, each tube 170 extends from one of the third electronic modules 130 to the second electronic module 120. The elastomeric tube 170 is similar to the elastomeric cover 160, except the elastomeric tube 170 does not include a cable disposed within the elastomeric tube 170, but instead has a hollow lumen 176 that extends from a first end 172 to a second end 174 of the elastomeric tube 170. In some examples the elastomeric tube 170 is defined by the elastomeric cover 160, or could be a separate tube disposed within the elastomeric cover. The elastomeric tube 170 can have a predetermined geometric pattern, can in some examples include a cable, and the elastomeric tube 170 can have an elastomeric constant spring force. The elastomeric constant spring force of the elastomeric tube 170 can be similar to the elastomeric constant spring force of the elastomeric cover 160 covering the cable 150. Similarly, the elastomeric tube 170 can supplement the tension force of the band 140 imparted by the elastomeric cover 160.

As discussed above, the third electronic module 130 can be speakers. Each third electronic module 130 can include an elastomeric tube 170 that couples the third electronic module 130 to a reservoir of air. The reservoir of air is configured to provide an audio back volume to the third electronic module 130. In some examples, the second electronic module 120 can further include a reservoir of air 124 or a plurality of reservoirs of air. Reservoirs of air can be disposed in other locations within the band 140. A connection between each third electronic module 130 and the second electronic module 120 enables the third electronic modules 130 to access the reservoir of air 124 disposed in the second electronic module 120, such that the speaker can emit a variety of different sound frequencies. The lumen 176 of the elastomeric tube 170 provides a closed system of air that each third electronic module 130 can access.

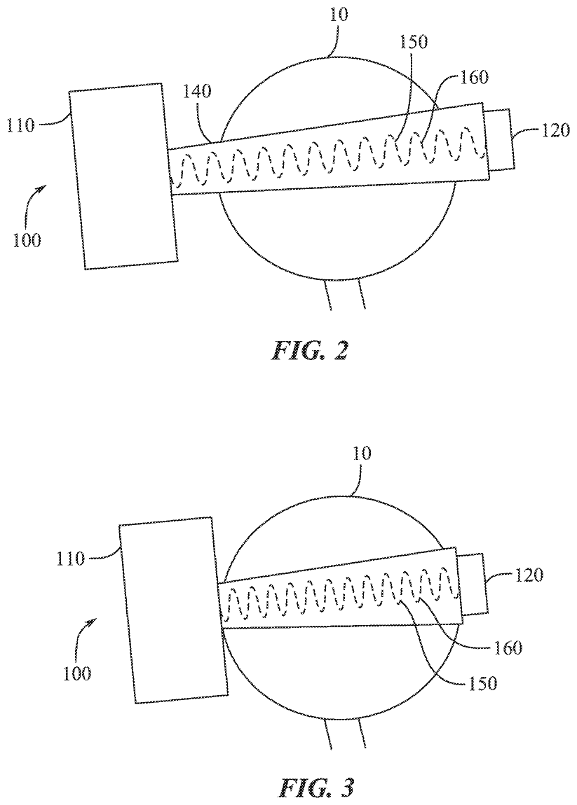

In some examples, and as shown in FIGS. 2 and 3, the wearable electronic device 100 can be worn on the user's head 10 such that the first electronic module 110 (e.g., HDM) is worn on the user's face and disposed over one or both of the user's eyes. The user can stretch the band 140 so that the band 140 is larger than the circumference of the user's head, as shown in FIG. 2. The user can then place the first electronic module 110 (e.g., HDM) over the user's eyes and the second electronic module 120 (e.g., battery) can be placed at the back of the user's head 10. As discussed previously, the second electronic module 120 can act as a counterweight to the first electronic module 110.

FIG. 3 illustrates the wearable electronic device 100 secured to the user's head 10. The elastomeric constant spring force of the elastomeric cover 160 of the cable imparts a tension force to the band 140 so that the wearable electronic device 100 is secured to the user's head. The tension force of the band 140 can be sufficient to secure the wearable electronic device 100 to the user's head 10, but not excessive that is uncomfortable to the user. In some examples, the tension force provided by the elastomeric cover 160 is combined with an elastic nature of the band 140 to provide the desired tension to comfortably retain the wearable electronic device 100 on the user's head 10.

As can be seen in FIGS. 1-3, the predetermined geometric pattern of the cable 150 is maintained as the band 140 transitions from an unconstrained state (e.g., natural or upstretched configuration, FIG. 1), to a stretched state (FIG. 2), and finally to a secured state (e.g., secured to a user's head 10, FIG. 3). The cable 150 in the unconstrained state of FIG. 1 is in the predetermined geometric pattern. The illustrated predetermined geometric pattern of FIG. 1 is a sine wave. The cable 150 in the stretched state of FIG. 2 illustrates the cable 150 substantially maintaining the geometric pattern of FIG. 1, while the peaks and valleys of the sine wave are stretched (e.g., further apart). The cable 150 in the secured state of FIG. 3 illustrates the cable 150 substantially maintaining the geometric pattern of FIGS. 1 and 2. Specifically, the cable 150 is slightly stretched compared to FIG. 1 with the peaks and valleys further apart and slightly more compact than in FIG. 2 with the peaks and valleys closer together.

The elastomeric constant spring force of the elastomeric cover 160 of the cable 150 facilitates the wearable electronic device 100 accommodating a wide range of head sizes across a population. The elastomeric constant spring force provides an added retention force used to secure the wearable electronic device 100 to the user's head.

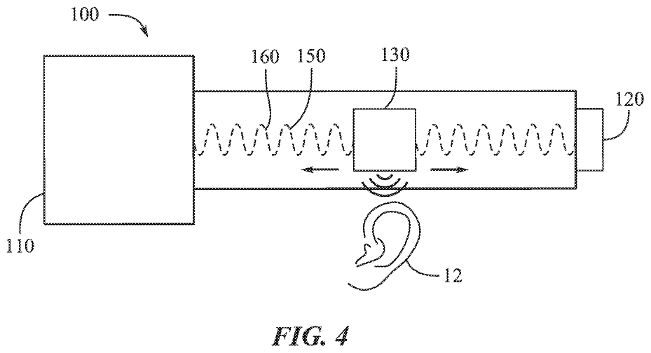

FIG. 4 illustrates the position of third electronic module 130 that includes a speaker relative to a user's ear 12. As discussed above, the wearable electronic device 100 can include multiple third electronic modules 130. For ease of disclosure, only a single third electronic module 130 is illustrated and described. The position of the third electronic module 130 relative to the ear 12 of the user when the user dons the wearable electronic device 100 can affect the performance of the speaker and audio output thereby, including spatial audio perceptions. In some examples, the position of the third electronic module 130 can be changed to place the third electronic module 130 in optimal locations along the band 140 to produce optimal sound output to the user's ears 12.

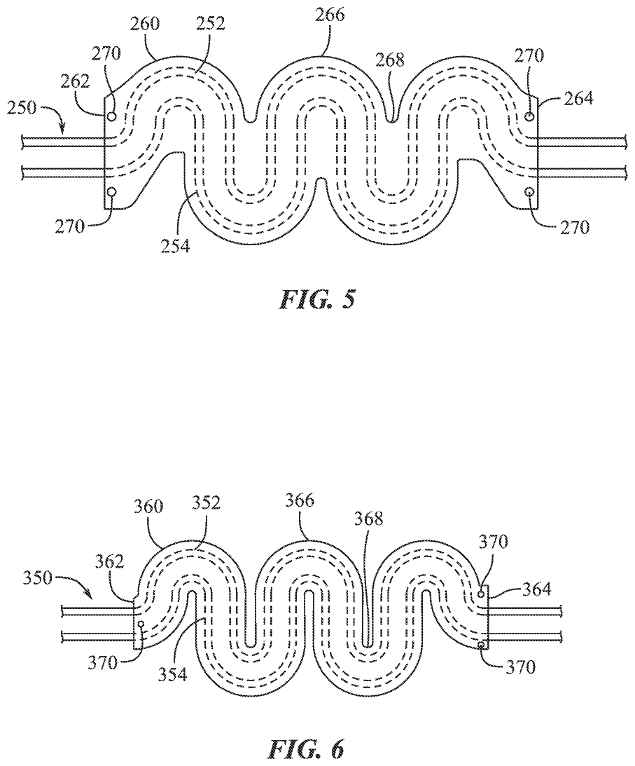

In some examples, an elastomeric cover 260 can include a plurality of cables 250 or conductors disposed within the elastomeric cover 260. In the illustrated embodiment of FIG. 5, the elastomeric cover 260 includes two cables 250, a first cable 252 and a second cable 254, that extend from a first end 262 of the elastomeric cover 260 to a second end 264 of the elastomeric cover 260. While the illustrated embodiment of FIG. 5 illustrates two cables 252, 254, the present disclosure is not so limited and the elastomeric cover 260 may include more than or less than two cables. The first cable 252 and the second cable 254 can have the same purpose, or they can have different purposes. For example, the first cable 252 can be dedicated to transmitting power, and the second cable 254 can be dedicated to transferring data.

The first cable 252 and the second cable 254 are disposed in a predetermined geometric pattern. In the illustrated embodiment, the first cable 252 and the second cable 254 are disposed in a sine wave pattern. Similarly, the elastomeric cover 260 has a similar sine wave pattern with a plurality of peaks 266 and a plurality of valleys 268. The shape of the valleys 268 of the elastomeric cover 260 relative to the plurality of cables 250 can increase or decrease the elastomeric constant spring force of the elastomeric cover. For example, a deeper valley can lead to the elastomeric cover 260 being stretched more and providing a greater restorative force than an elastomeric cover having shallow valleys. Accordingly, the deeper the valley 268 the more stretch the elastomeric cover 260 can achieve, and the shallower the valley 268, the smaller the stretch the elastomeric cover 260 can achieve. The illustrated embodiment of FIG. 5 illustrates relatively shallow valleys. The amount of stretch that the elastomeric cover 260 allows affects tension provided to the band 140, the amount of retention force provided to the band 140, and the change in length that the band 140 can achieve.

The plurality of cables 250 can extend out of the first end 262 and the second end 264 of the elastomeric cover so that the cables 252, 254 can electrically connect with the first electronic module 110, the second electronic module 120, and the third electronic module 130. While not shown, an electrical connector (similar to 180 in FIG. 1) can be disposed at each of the first end 262 and the second end 264 of the elastomeric cover 260. Each electrical connector can be removably attachable both electrically and physically to the first electronic module 110 (e.g., HMD). The elastomeric cover 260 can include fasteners 270 disposed at the first end 262 and at the second end 264 to fixedly connect the elastomeric cover 260 to the electrical connector. The fixed coupling between the elastomeric cover 260 and the electrical connector ensures that the elastomeric constant spring force has a fixed point of origination at both ends 262, 264 of the elastomeric cover 260. The illustrated embodiment illustrates the fasteners 270 disposed above and below the plurality of cables 250 on both ends 262, 264 of the elastomeric cover 260. However, there can be more or less than two fasteners 270 on both ends 262, 264 of the elastomeric cover 260 and the fasteners 270 can be disposed in different locations than the illustrated locations.

FIG. 6 illustrates another exemplary embodiment of an elastomeric cover 360 including a plurality of cables 350 disposed within the elastomeric cover 360, including a first cable 352 and a second cable 354. Similar to the embodiment of FIG. 5, the first cable 352 and the second cable 354 each have a sine wave pattern.

The embodiment of FIG. 6 is slightly different than the embodiment of FIG. 5. Specifically, the valleys 368 of the elastomeric cover 360 are deeper than the valleys 268 of elastomeric cover 260. The deeper valleys 368 of the elastomeric cover 360 would allow for more stretch than the elastomeric cover 260 of FIG. 5.

In addition, fasteners 370 of the elastomeric cover 360 are disposed in a different location on a first end 362 of the elastomeric cover 360 than the first end 262 of the elastomeric cover 260. The first end 362 of the elastomeric cover includes a single fastener 370 that is disposed between the first cable 352 and the second cable 354.

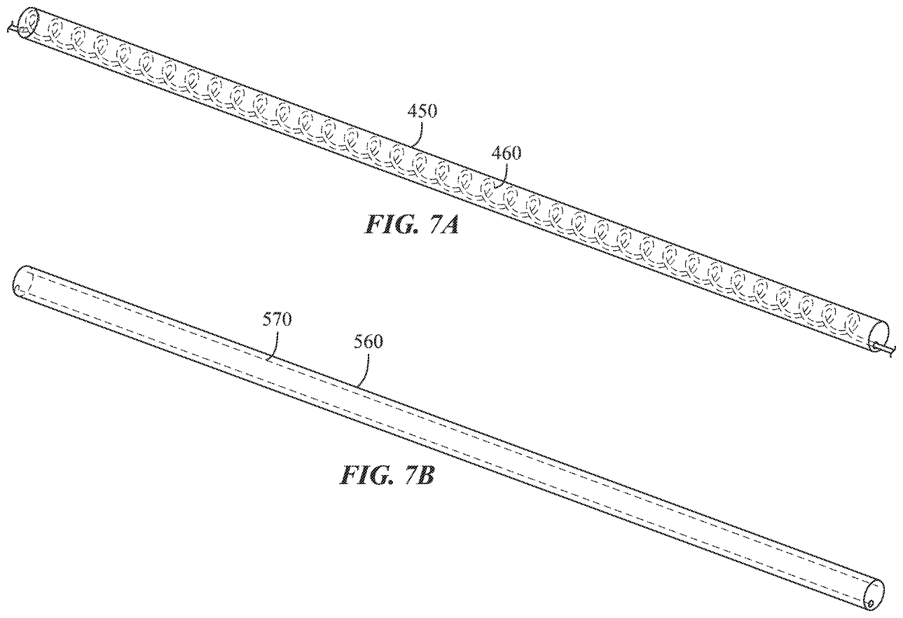

FIG. 7A illustrates a cable 450 disposed within an elastomeric cover 460 that can be disposed within the band 140. The elastomeric cover 460 provides an elastomeric constant spring force so that when the band 140 is stretched, the elastomeric cover 460 stretches with the band 140 when the band is constrained and then the elastomeric cover 460 resiliently returns to its unconstrained state when a force is not being applied to stretch the band 140. In the illustrated embodiment of FIG. 7A, the cable 450 can have a helical coil shape. The shape of the cable 450 is not limited to a helical coil and can have a number of different shapes that enable the cable 450 to elongate without putting excess force on the cable 450 to break the cable 450. Additional structure include sine wave, S bend, squared coil, snake bend, and the like.

The shape of cable 450 prevents the cable 450 from breaking when a force is applied to the band 140 to stretch the band 140 as the helical coil shape enables the cable 450 to stretch without applying a strong tension force to the cable 450. In other words, the cable 450 begins to elongate as tension is applied to the cable 450, and consequently the helical coil shape of the cable 450 tightens. Accordingly, this enables the elastomeric cover 460 to stretch without fear of the cable 450 breaking when a force is applied to the cable 450 and the elastomeric cover 460. The size and shape of the helical coil shape can be adjusted and tuned to provide a desired amount of stretching or extension.

FIG. 7B illustrates an exemplary elastomeric tube 670 with a lumen 672. As discussed the elastomeric tube 670 can provide access for the third electronic module 130 (e.g., speaker) to access a reservoir of air. As shown, the elastomeric tube 670 of FIG. 7B does not contain any cables. However, the elastomeric tube 670 can have any number of cables, while also defining a lumen 672 that can provide access to a remove volume to help facilitate the performance of an electronic module, such as a speaker. Additional geometric patterns for the cable and the elastomeric cover are provided below with reference to FIGS. 8-12.

FIGS. 8-12 illustrate a variety of different geometric patterns for the cable and the elastomeric cover. In some examples, the geometric pattern is a repeating geometric pattern. In some embodiments, the geometric pattern is a non-repeating pattern. FIG. 8 illustrates a band 640 with a cable 650 and an elastomeric cover 660 disposed within the band 640. The cable 650 can include a plurality of wires, with each wire dedicated to a specific function, such a group wire, data transfer, power transfer, and the like. Each wire can be insulated from the other wires either by an insulative sheath or by the elastomeric cover 660.

A first electrical connector 680 is disposed at a first end 642 of the band 640, and a second electrical connector 690 is disposed at a second end 644 of the band 640. The cable 650 extends into both electrical connectors 680 and 690. The electrical connectors 680 and 690 are removably attachable to the first electronic module (not shown). The cable 650 is also coupled to a second electronic module 620. The cable 650 and the elastomeric cover 660 include a first segment 652 that electrically couples the first electrical connector 680 to the second electronic module 620, and a second segment 654 that electrically couples the second electronic module 620 to the second electrical connector 690. The cable 650 and the elastomeric cover 660 of FIG. 8 include a sine wave geometric pattern which maintains the cable 650 in a predetermined location within the band 640 and imparts a tension force to the band 640, the tension force corresponding to an elastomeric spring force of the elastomeric cover 660. The illustrated sine wave geometric pattern is a repeating geometric pattern.

FIG. 9 illustrates a band 740 with a cable 750 and an elastomeric cover 760 disposed within the band 740. A first electrical connector 780 is disposed at a first end 742 of the band 740, and a second electrical connector 790 is disposed at a second end 744 of the band 740. The cable 750 extends into both of the electrical connectors 780 and 790. The electrical connectors 780 and 790 and removably attachable to the first electronic module (not shown). The cable 750 is also coupled to a second electronic module 720. The cable 750 and the elastomeric cover 760 include a first segment 752 that electrically couples the first electrical connector 780 to the second electronic module 720 and a second segment 754 that electrically couples the second electronic module 720 to the second electrical connector 790. The cable 750 and the elastomeric cover 760 of FIG. 9 include an S bend geometric pattern which maintains the cable 750 in a predetermined location within the band 740, and imparts a tension force to the band 740, the tension force corresponding to an elastomeric spring force of the elastomeric cover 760. The S bend geometric pattern is an example of a non-repeating geometric pattern.

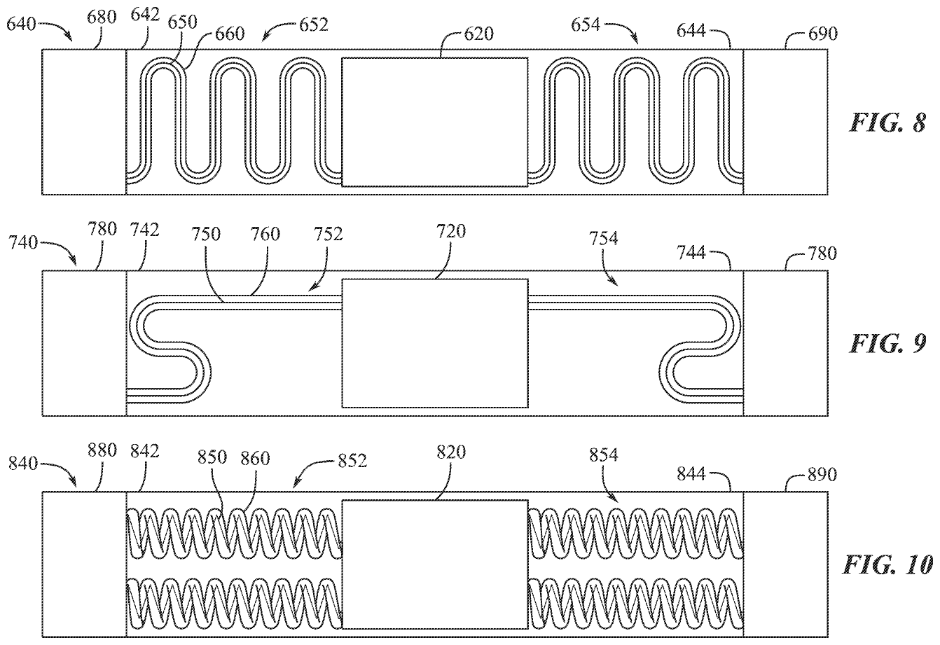

FIG. 10 illustrates a band 840 with a plurality of cables 850, each with an elastomeric cover 860 disposed within the band 840. A first electrical connector 880 is disposed at a first end 842 of the band 840, and a second electrical connector 890 is disposed at a second end 844 of the band 840. The cables 850 extend into both of the electrical connectors 880 and 890. The electrical connectors 880 and 890 are removably attachable to the first electronic module (not shown). The cable 850 is also coupled to a second electronic module 820. The cable 850 and the elastomeric cover 860 include a first segment 852 that electrically couples the first electrical connector 880 to the second electronic module 820, and a second segment 854 that electrically couples the second electronic module 820 to the second electrical connector 890. The cables 850 and the elastomeric cover 860 of FIG. 10 include a helical coil geometric pattern which maintains the cables 850 in a predetermined location within the band 840, and imparts a tension force to the band 840, the tension force corresponding to an elastomeric spring force of the elastomeric cover 860. The helical coil geometric pattern shown in FIG. 10 is an example of a repeating geometric pattern.

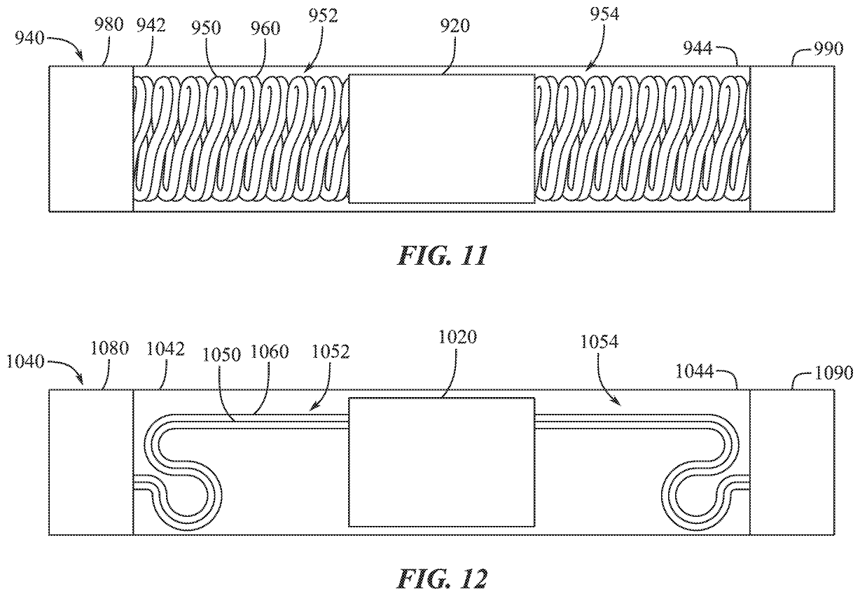

FIG. 11 illustrates a band 940 with a cable 950 and an elastomeric cover 960 disposed within the band 940. A first electrical connector 980 is disposed at a first end 942 of the band 940, and a second electrical connector 990 is disposed at a second end 944 of the band 940. The cable 950 extends into both of the electrical connectors 980 and 990. The electrical connectors 980 and 990 are removably attachable to the first electronic module (not shown). The cable 950 is also coupled to a second electronic module 920. The cable 950 and the elastomeric cover 960 include a first segment 952 that electrically couples the first electrical connector 980 to the second electronic module 920, and a second segment 954 that electrically couples the second electronic module 920 to the second electrical connector 990. The cable 950 and the elastomeric cover 960 of FIG. 11 include a square coil geometric pattern which maintains the cable 950 in a predetermined location within the band 940 and imparts a tension force to the band 940, the tension force corresponding to an elastomeric spring force of the elastomeric cover 960. The square coil geometric pattern is an example of a repeating geometric pattern.

FIG. 12 illustrates a band 1040 with a cable 1050 and an elastomeric cover 1060 disposed within the band 1040. A first electrical connector 1080 is disposed at a first end 1042 of the band 1040 and a second electrical connector 1090 is disposed at a second end 1044 of the band 1040. The cable 1050 extends into both of the electrical connectors 1080 and 1090. The electrical connectors 1080 and 1090 are removably attachable to the first electronic module (not shown). The cable 1050 is also coupled to a second electronic module 1020. The cable 1050 and the elastomeric cover 1060 include a first segment 1052 that electrically couples the first electrical connector 1080 to the second electronic module 1020, and a second segment 1054 that electrically couples the second electronic module 1020 to the second electrical connector 1090. The cable 1050 and the elastomeric cover 1060 of FIG. 12 include a snake bend geometric pattern which maintains the cable 1050 in a predetermined location within the band 1040, and imparts a tension force to the band 1040, the tension force corresponding to an elastomeric spring force of the elastomeric cover 1060. The snake bend geometric pattern is an example of a non-repeating geometric pattern.

According to some examples, the systems and methods contemplated herein can further enhance a user experience, or can customize user settings, by collecting, saving, using, and/or transmitting user information data. If such user information data is used, it should be used according to well-established and accepted best practices, and should aim to avoid any un-authorized access or dissemination of user information data. In some examples, the user information data should be anonymized. However, the present systems and methods do not require the collection of user information data for operation.

The foregoing description utilized specific nomenclature to provide a thorough understanding of the exemplary systems and methods. However, the specific details are not required in order to practice the described embodiments. Rather, the foregoing descriptions of the specific embodiments described herein are presented for purposes of illustration and description, and are not intended to be exhaustive or to limit the embodiments to the precise forms disclosed. Additionally, many modifications and variations are possible in view of the above teachings.

What is claimed is:

1. A head mountable display comprising:
a housing;
a display attached to the housing;
a band including a first end and a second end;
a first electrical connector disposed at the first end, the first electrical connector removably attachable to a first surface of the housing;
a second electrical connector disposed at the second end, the second electrical connector removably attachable to a second surface of the housing;
a battery electrically attachable to the band;
a cable positioned within the band electrically connecting the battery to the first electrical connector; and
an elastomeric cover disposed around the cable, the elastomeric cover imparting a tension force to the band.

2. The head mountable display of claim 1, wherein the tension force corresponds to an elastomeric spring force of the elastomeric cover.

3. The head mountable display of claim 1, wherein the elastomeric cover is fixedly connected to the first electrical connector and to the second electrical connector.

4. The head mountable display of claim 1, further comprising a speaker disposed within the band, the speaker electrically connected to the battery and to the display via the cable.

5. The head mountable display of claim 4, further comprising a lumen defined by the elastomeric cover, the lumen extending from the speaker to an open volume.

6. The head mountable display of claim 5, wherein the open volume is defined by the battery.

7. The head mountable display of claim 1, wherein the cable comprises a first cable, and further comprising a second cable;
wherein the elastomeric cover is disposed around the first cable and the second cable.

8. A band for coupling a first electronic to a second electronic, the band comprising:
a body having a first end and a second end;
a cable positioned within the body and configured to electrically connect the first electronic to the second electronic, the cable comprising:
a first conductor;
a second conductor; and
an elastomeric cover disposed around the first conduct and the second conductor, the elastomeric cover providing an elastomeric spring force to the band,
wherein the cable is maintained in a predetermined geometric pattern in an unconstrained state.

9. The band of claim 8, wherein the predetermined geometric pattern is repeating.

10. The band of claim 9, wherein the predetermined geometric pattern comprises a sine wave.

11. The band of claim 8, wherein the predetermined geometric pattern comprises an S bend.

12. The band of claim 8, wherein a first insulator is disposed around the first conductor and a second insulator is disposed around the second conductor.

13. The band of claim 8, further comprising:
a first fastener at the first end of the band; and
a second fastener at the second end of the band.

14. A wearable electronic device comprising:
a display;
a battery;
a flexible band connecting the display to the battery;
a first conductor and a second conductor disposed within the flexible band; and
an elastomeric cover surrounding the first conductor and the second conductor;
wherein the elastomeric cover imparts a tension force to the band.

15. The wearable electronic device of claim 14, wherein the elastomeric cover maintains the first conductor and the second conductor in a predetermined location in the band.

16. The wearable electronic device of claim 14, wherein the first conductor and the second conductor have a helical coil shape.

17. The wearable electronic device of claim 14, wherein the elastomeric cover insulates the first and second conductor.

18. The wearable electronic device of claim 14, further comprising:
a first insulator disposed between the first conductor and the elastomeric cover; and
a second insulator disposed between the second conductor and the elastomeric cover.

19. The wearable electronic device of claim 14, further comprising an electronic, wherein the electronic is electrically connected to the display and the battery via the first conductor and the second conductor.

20. The wearable electronic device of claim 19, wherein:
the electronic comprises a speaker; and
the elastomeric cover defines a lumen, the lumen extending from the speaker to a remote volume within the wearable electronic device.
